(19) United States
(12) Patent Application Publication
(10) Pub. No.: US 2014/0067538 A1
(43) Pub. Date: Mar. 6, 2014

(54) METHODS, SYSTEMS, AND MEDIA FOR INHIBITING ADVERTISEMENT COLLISIONS

(71) Applicant: Media6Degrees, Inc., New York, NY (US)

(72) Inventors: Rodney HOOK, New York, NY (US); Tommy Yiwel MEI, New York, NY (US); Stanley KUBASEK, Glen Rock, NJ (US)

(73) Assignee: MEDA6DEGREES, INC., New York, NY (US)

(21) Appl. No.: 13/973,405

(22) Filed: Aug. 22, 2013

Related U.S. Application Data
(60) Provisional application No. 61/697,529, filed on Sep. 6, 2012.

(51) Int. Cl. G06Q 30/02

(52) U.S. Cl. CPC G06Q 30/0257
USPC 705/14.55; 705/14.71

(57) ABSTRACT

In some embodiments, a mediator device is operable to receive a request for permission to serve a first advertisement associated with a first advertiser to a display device. The mediator device can set a lock indicator to an active state in response to receiving the request and send an indication of approval to serve the first advertisement. The mediator device can receive, at a later time, a request for permission to serve a second advertisement to the display device. The mediator device can decline to send an indication of approval to serve the second advertisement when the lock indicator is in the active state.

### CROSS REFERENCE TO RELATED APPLICATIONS

This application claims priority to U.S. Patent Application No. 61/697,529 entitled “Methods, Systems, and Media for Inhibiting Advertisement Collisions,” filed Sep. 6, 2012, which is incorporated herein by reference its entirety.

### BACKGROUND

On demand advertisement placement is desired by advertisers and a growing part of the economy, particularly the internet economy. Companies selling advertisements for on-demand placement are offering increasingly sophisticated methods for identifying the target audience and serving relevant advertisements. Furthermore, advertisers are demanding increasingly sophisticated advertising campaigns to maximize the effectiveness of their advertisements.

The interaction between exposure to an advertisement and advertising effectiveness is complex. For example, road-block advertising and/or saturation advertising, in which a target is exposed to advertisements associated with the same advertiser repeatedly can be highly effective but can also be very expensive. In particular, an advertiser conducting a road-block campaign may pay a premium for ad space to assure that the target receives a consistent advertising message. While road-block and/or saturation advertising can be an appropriate strategy for some campaigns (e.g., high value campaigns and/or campaigns targeting a small audience), in other situations, an advertiser may prefer to maximize the number of first-impressions and/or minimize advertising collisions.

In general, the marginal effectiveness of an advertisement decreases with each subsequent view. Therefore, an advertiser wishing to maximize the cost-effectiveness of a campaign and/or an advertiser wishing to reach the largest possible audience may not wish to serve the same target the same advertisement repeatedly, and/or may be willing to pay more for a first-impression than subsequent impressions. Similarly stated, the cost an advertiser is willing to pay for an impression may be a function of the number of times the target has previously viewed the advertisement.

Real-time bidding (RTB) can allow advertisers to bid on individual ad spaces (e.g., individual impressions) served to individual advertisement canvases on user devices. For example, when a user accesses a web page, an ad space on the web page redirects to user's browser to an RTB device. The RTB device can collect information from the user's browser, such as cookie information and the referring web address, which allows advertisers to bid on an impression based on some information about the user and where the advertisement will appear. For example, the RTB device can receive information associated with a tracking cookie, which can be tied to the user's browsing habits and/or the history of advertisements served to the user. Using this data, advertisers can bid on the user and can adjust their price based on, for example, how frequently the user has been exposed to the advertiser's campaign.

An advertisement canvas can have more than one ad space, which can be served by more than one RTB device. When advertisements are selected for such an advertisement canvas, each RTB device can conduct a parallel auction. As a result, because of the automated nature and fast timescales involved in RTB, advertisers have typically been unable to effectively adjust bids based on other ad spaces on the advertisement canvases, and an advertising collision may result. For example, if a new user visits a web page with two ad spaces, each directing to a different RTB device, each RTB device may bill the ad space as a “first” impression. As a result, an advertiser placing a premium on first impressions may win two parallel auctions for a “first” impression. In this way, known systems can cause an advertiser to unwittingly and unwillingly build a road-block advertising campaign when the advertiser would prefer to only pay for one “first” impression advertisement.

Accordingly, a need exists for methods, systems, and media for inhibiting advertisement collisions.

### SUMMARY

In some embodiments, a mediator device is operable to receive a request for permission to serve a first advertisement associated with a first advertiser to a display device. The mediator device can set a lock indicator to an active state in response to receiving the request and send an indication of approval to serve the first advertisement. The mediator device can receive, at a later time, a request for permission to serve a second advertisement to the display device. The mediator device can decline to send an indication of approval to serve the second advertisement when the lock indicator is in the active state.

### BRIEF DESCRIPTION OF THE DRAWINGS

FIG. 1 is a schematic diagram of a system for filling ad space on an advertisement canvas, according to an embodiment.

FIGS. 2 and 3 are schematic diagrams of systems for filling ad space on an advertisement canvas using real-time bidding devices, according to other embodiments.

FIG. 4 is a flow chart of a method of operating a mediator device, according to an embodiment.

FIG. 5 is a flow chart of a method of operating a programmatic buying platform, according to an embodiment.

FIG. 6 is a flow chart of a method of operating a real time bidding device, according to an embodiment.

### DETAILED DESCRIPTION

In one embodiment, a mediator device can be operable to inhibit advertising collisions through the use of exclusive lock indicators. The mediator device can be configured to receive requests from advertisement devices for permission to serve advertisements to a display device. The requests can include information associated with the advertisement, the display device, the user of the display device, etc. Upon receiving a request to serve a first advertisement from a first advertisement device, the mediator device can be operable to set a lock indicator to an active state. The lock indicator can be associated with the advertisement, the advertiser, and/or the display device, etc. At a later time, the mediator device can receive a request from a second advertisement device to serve a second advertisement. The mediator device can be operable to decline to send approval to the second advertisement device to serve the second advertisement when the lock indicator is in the active state. Optionally, the mediator device can decline to send approval to serve the second advertisement where the second advertisement would represent a collision with the first advertisement, for example, because the first and second advertisements are associated with the same advertiser and/or the same category of product and would appear on the same advertisement canvas. Optionally, in addition to declining to send approval to serve the second advertisement, the mediator device can send a denial of approval to the second advertisement device.

After sending a denial to the second advertisement device, the mediator device can be operable to receive a request from the second advertisement device to serve a third advertisement. The mediator device can send approval to the second advertisement device to serve the third advertisement, for example, where the third advertisement does not represent a collision with the first advertisement.

In one embodiment, a programmatic buying platform can be operable to request permission before bidding an advertisement. Requesting permission from, e.g., a mediator device, can be operable to inhibit advertising collisions.

The programmatic buying platform can receive an invitation to participate in an auction for an ad space that can be presented on an advertisement canvas via a display device. The invitation to participate can include information about the ad space, such as details about the advertisement canvas, information about the user(s) who will view the advertisement canvas, information about the display device, etc., which can enable the programmatic buying platform to select an appropriate advertisement, and calculate the value of placing the advertisement on the ad space. The programmatic buying platform can send a request to bid the advisement to the mediator device. The request to bid the advertisement can include information associated with the advertisement, the ad space, the advertisement canvas, the display device, the user(s), etc. The request to bid the advertisement can result in the mediator device defining a lock indicator, which can prevent subsequent programmatic buying platforms from bidding colliding advertisements.

The programmatic buying platform can receive a signal, e.g., from the mediator device, that either approves the request to bid the advertisement or denies the request to bid the advertisement. If the programmatic buying platform receives a denial, the programmatic buying platform can optionally select another advertisement and request permission to bid the other advertisement. If the programmatic buying platform receives approval, it can place a bid to have the advertisement appear displayed on the advertisement canvas, which can be displayed on the display device. In some embodiments, if the programmatic buying platform wins the auction, the programmatic buying platform can be operable to serve the advertisement to the display device. Similarly stated, the programmatic buying platform can host the advertisement and send advertising content to the display device.

In one embodiment, a real time bidding device can be operable to request permission before conducting an auction for an ad space. Requesting permission from, e.g., a mediator device can be operable to inhibit advertising collisions.

The real time bidding device can receive a request from a display device to serve an advertisement in an ad space. The request can include information about the ad space, such as information about the advertisement canvas, the display device, the user(s), etc. Optionally, the real time bidding device can solicit bids from programmatic buying platforms to bid on the ad space.

The real time bidding device can receive a bid from the ad space, e.g., from one or more programmatic buying platforms. Each bid can include information about the bid advertisement, such as details about the advertiser, the category, the offered compensation, etc. The real time bidding device can select a winning bid.

The real time bidding device can request permission to serve the advertisement. Optionally, requesting permission can include sending information about a bid to a mediator device. Sending the request for permission can cause the mediator device to set a lock indicator to an active state, which can be operable to inhibit advertising collisions. Alternatively, the real time bidding device can be operable to search a conflict database to verify that no lock indicator is active, set a lock indicator if no conflict is detected, and/or generate the indication of approval. In some embodiments, if an indication of disapproval is received, the real time bidding device can select a next-winning bid and request permission to serve the next-winning advertisement.

Having received approval, the real time bidding device can redirect the display device to the programmatic buying platform, such that the programmatic buying platform can serve the advertisement to the display device.

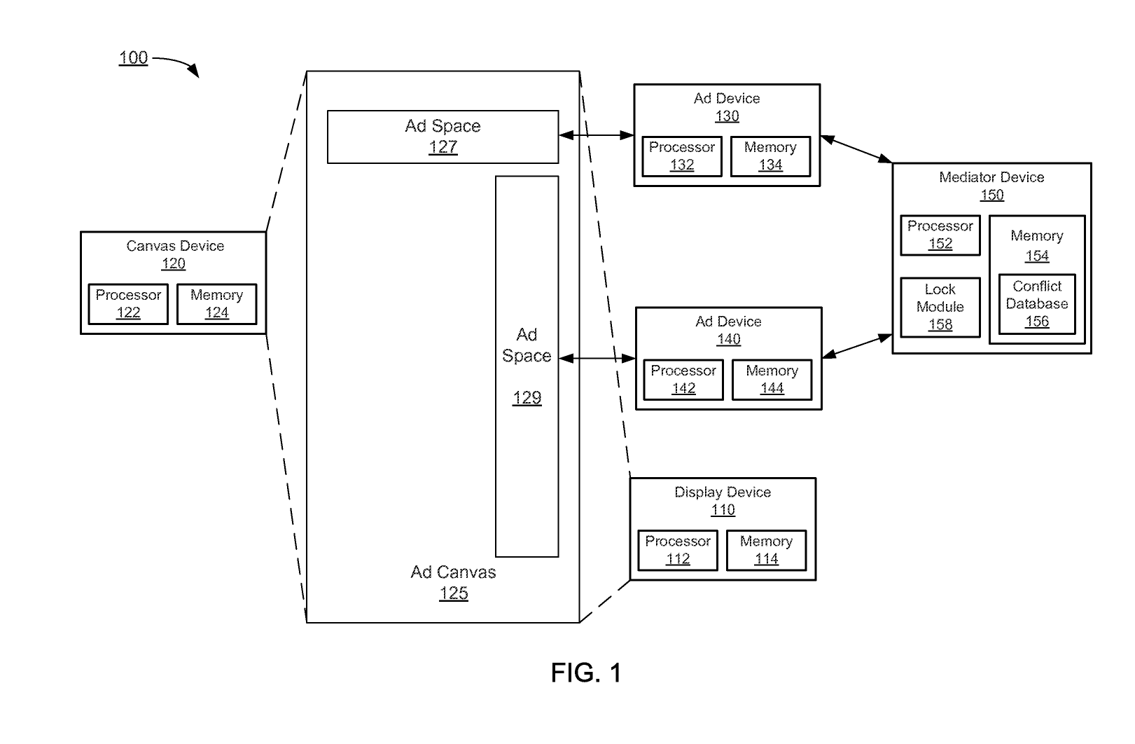

FIG. 1 is a schematic diagram of a system 100 for filling ad space 127, 129 on an advertisement canvas 125, according to an embodiment. The system includes a canvas device 120, a display device 110, two advertisement devices 130, 140, and a mediator device 150. The canvas device 120, the display device 110, the advertisement devices 130, 140, and/or the mediator device 150 can be communicatively coupled, e.g., via a network (such as the internet, an intranet, a local area network (LAN), a wide area network (WAN), a virtual network, and/or a telecommunications network) implemented as a wired network and/or wireless network.

The canvas device 120 can be a computing entity (e.g., server; a personal computing device such as a desktop computer, a laptop computer, a netbook, a tablet personal computer, an iPod®, an iPad®; a smart phone, e.g., an iPhone®, an Android® phone, a Blackberry®, a Windows® phone, etc.; a mobile phone; a personal digital assistant; etc.). The canvas device 120 can be operable to send and receive signals, store and retrieve data, and/or execute modules.

The canvas device 120 includes a processor 122 and a memory 124. The processor 122 can be, for example, a general purpose processor, a Field Programmable Gate Array (FPGA), an Application Specific Integrated Circuit (ASIC), a Digital Signal Processor (DSP), and/or the like. The processor 122 can be configured to retrieve data from and/or write data to the memory 124. The memory 124 can be, for example, a random access memory (RAM), a memory buffer, a hard drive, a database, an erasable programmable read only memory (EPROM), an electrically erasable programmable read only memory (EEPROM), a read only memory (ROM), a flash memory, a hard disk, a floppy disk, cloud storage, and/or so forth. In some embodiments, the canvas device can include one or more hardware-based modules (e.g., implemented within a DSP, FPGA, ASIC) and/or software-based modules (e.g., a module of computer code stored at the memory 124 and/or executed at the processor 122, a set of processor-readable instructions that can be stored at the memory 124 and/or executed at the processor 122) associated with executing an application, for example, to generate content for the advertisement canvas 125, to solicit content for the ad spaces 127, 129, to transmit and/or display the advertisement canvas 125, etc.

In one embodiment, the canvas device 120 can be a web server operable to store code representing the advertisement canvas 125, which can be a web page containing the ad spaces 127, 129. The canvas device 120 can be associated with an internet protocol (IP) address, a domain name, and/or one or more uniform resource locators (URLs), which can identify the canvas device 120 and/or the advertisement canvas 125. The canvas device 120 can be operable to send, e.g., to the display device 110, code associated with the advertisement canvas 125 upon request. For example, the canvas device 120 can be operable to send code associated with a web page when the user of the display device 110 directs a web browser to a URL associated with the web page.

The display device 110, the first advertisement server 130, the second advertisement server 140, and/or the mediator device 150 can each be a computing entity. The display device 110, the first advertisement server 130, the second advertisement server 140, and the mediator device 150 each includes a memory 114, 134, 144, 154, and a processor 112, 132, 142, 154, respectively. The memory 114, 134, 144, 154, and/or the processor 112, 132, 142, 154 can be structurally similar to the memory 124 and/or the processor 122, respectively.

In some embodiments, the display device 110 is a personal computing entity operable to retrieve web pages from web servers, such as the ad canvas 125 from the canvas device 120. Such a personal computing entity can be operable to execute code, such as HTML, associated with the advertisement canvas 125. Code associated with the advertisement canvas 125 can be operable to cause the display device to retrieve advertising content from the advertisement devices 130, 140 to fill the ad space 127, 129.

In another embodiment, the display device 110 can be associated with an electronic billboard and/or other signage. For example, an electronic advertising device, such as billboard can be placed in a public space, such as a shopping mall or sport arena. The display device 110 can receive data from the canvas device 120 associated with the advertisement canvas, e.g., via an intranet. As described in further detail herein, the canvas device 120 can receive advertising content to fill the ad spaces 127, 129 from the advertisement devices 130, 140.

The advertisement devices 130, 140 can be operable to store code associated with advertisements (e.g., in the memory 134, 144). The advertisement devices 130, 140 can be associated with an IP address, a domain names, and/or one or more URLs, which can identify the advertisement devices 130, 140. The advertisement devices 130, 140 can be operable to send, e.g., to the display device 110, code associated with advertisements selected to fill the ad space 127, 129. For example, the advertisement servers 130, 140 can be operable to send code associated with filling ad space 127, 129 when code associated with the advertisement canvas 125 directs a web browser executing on the display device 110 to an address associated with the ad space 127, 129.

Code sent from the canvas device 120 to the display device 110 (operable to cause the display device 110 to display the advertisement canvas 125) can include, for example, content information, layout information, referral information, etc. The advertisement canvas 125 can be rendered by the display device executing instructions (e.g., with the processor 112), which can include requesting and/or receiving data from other computing entities (e.g., other web servers, which can include the advertisement devices 130, 140).

Code associated with the ad spaces 127, 129 can be operable to cause the display device 110 to request an advertisement from the advertisement devices 130, 140. As shown, the advertisement canvas 125 includes a banner ad space 127 and a skyscraper ad space 129. Each ad space can be associated with instructions for the display device 110 to request an advertisement from a different advertisement server. As shown, the code associated with the banner ad space 127 refers the display device 110 to a first advertisement device 130 for banner ad content, and the skyscraper ad space 129 refers the display device 110 to a second advertisement device 140 for skyscraper ad content.

The mediator device 150 can be operable to inhibit advertising collisions in contrast to known systems in which multiple advertisement devices independently generate advertising content for ad spaces without consulting a mediator device. For example, before sending code associated with an advertisement to fill the ad space 127, 129, each of the advertisement devices 130, 140 can seek approval from the mediator device 150. For example, in response to a request from the display device 110 for the first advertisement device 130 to fill the banner ad space 127, the first advertisement device 130 can tentatively select a first advertisement, while the second advertisement device 140 can tentatively select a second advertisement. The first advertisement device 130 can send a signal to the mediator device 150 including an indication of the user associated with the display device 110, an indication associated with the advertisement canvas 125 (e.g., a URL associated with a webpage), an indication of an advertiser associated with the tentatively-selected first advertisement, etc.

In response to receiving the signal from the first advertisement device 130, the mediator device 150 can be operable to execute a lock module 158 (e.g., on the processor 152). The lock module 158 can be operable to examine a conflict database 156 (e.g., stored in the memory 154) to determine whether a conflict exists. For example, the lock module 158 can examine the conflict database 156 to determine whether an exclusive lock has been defined.

The conflict database 156 can include a list of rules that define conflicts. For example, the conflict database can specify that if the request to serve the advertisement includes an indication that matches any one or any combination of advertiser, advertisement, advertisement canvas, user, user device, advertiser category, etc., it constitutes a conflict. The lock module 158 can be operable to determine whether any entries in the conflict database 156 define the request as a conflict.

If the lock module 158 detects a conflict, the mediator device 150 can deny the request from the first advertisement server 130 to serve the tentatively selected first advertisement. Conversely, if the lock module 158 detects no conflict, the mediator device 150 can approve the request from the first advertisement device 130 to serve the tentatively selected first advertisement.

In some embodiments, the mediator device 150 can be operable to receive a signal requesting approval to serve an advertisement from an advertising device 130, 140 and return a signal either granting or denying the request in less than approximately 1 second, less than approximately 0.5 seconds, less than approximately 0.1 seconds, less than approximately 0.01 seconds, or less than approximately 0.001 seconds.

If the request to serve the tentatively-selected first advertisement is approved, the lock module 158 can be operable to submit a new entry to the conflict database 156 to define an exclusive lock associated with a user associated with the display device, the advertisement canvas 125, and/or the advertiser associated with the first advertisement. Thus, if the mediator device 150 receives a subsequent request to serve an advertisement that would conflict with the lock (e.g., the second advertisement device 140 sends a request to fill the skyscraper ad space 129 with an advertisement associated with the advertiser for the first advertisement) the mediator device 150 can deny the request.

The lock module 158 can be operable to determine which new entries to submit to the conflict database 156. In some embodiments, the mediator device 150 can store a list of conflicts associated with each advertisement, each advertiser, each advertisement category, etc. For example, the mediator device 150 can receive instructions, e.g., from an advertiser, indicating which advertisements should be considered conflicts. In some instances, advertisements from the same advertiser can be considered conflicts. In other instances, advertisements from competing advertisers can be considered conflicts. In yet other instances, any advertiser and/or advertisement on a black list can be considered conflicts. Alternatively, unless an advertiser and/or advertisement is on a white list, an advertisement can be considered a conflict. In still other instances, advertisements of a particular category (e.g., the same category as the advertisement and/or categories with which the advertiser does not want to be associated) can be considered conflicts. In addition or alternatively, conflicts can specify particular canvas devices, advertisement canvases, display devices, users of display devices, and so forth. The lock module 158 can be operable to submit a conflict that has any number of parameters, and combination of parameters, and/or conditional conflicts.

In some embodiments, the lock module 158 can be configured to search for a conflict and define a lock simultaneously. Similarly stated, the conflict search and defining the lock can be atomic.

The conflicts stored in the conflict database 156 can be stored for a limited amount of time. For example, in instances where the mediator device 150 is configured to inhibit same-page conflicts (e.g., advertisements associated with the same advertiser on the same web page served to the same user), the locks can be configured to expire after a typical web page load time has elapsed. For example, the locks can expire after 10 seconds, after 5 seconds, after 1 second, or after 0.5 seconds. In other instances, such as where the first advertisement device 130 and the second advertisement device 140 are part of the same advertising network (but may be geographically separated), the locks can be configured to expire after the first advertisement device 130 and the second advertisement device 140 have had an opportunity to synch tracking cookies. For example, the locks can expire after 10 minutes, 5 minutes, 2, minutes, 1 minute, 30 seconds, or after 10 seconds. In other instances, the locks can be permanent or can expire after any suitable time period, for example, a time period specified by the advertiser. In some instances, the expiration of locks can be configured to minimize the number of conflicts in the conflict database 156, which can serve to minimize the time required to search the database. For example, the oldest conflicts in the conflict database 156 can be deleted if a search of the conflict database 156 takes longer than 1 second, longer than 0.5 seconds, longer than 0.1 seconds, longer than 0.01 seconds, or longer than 0.001 seconds.

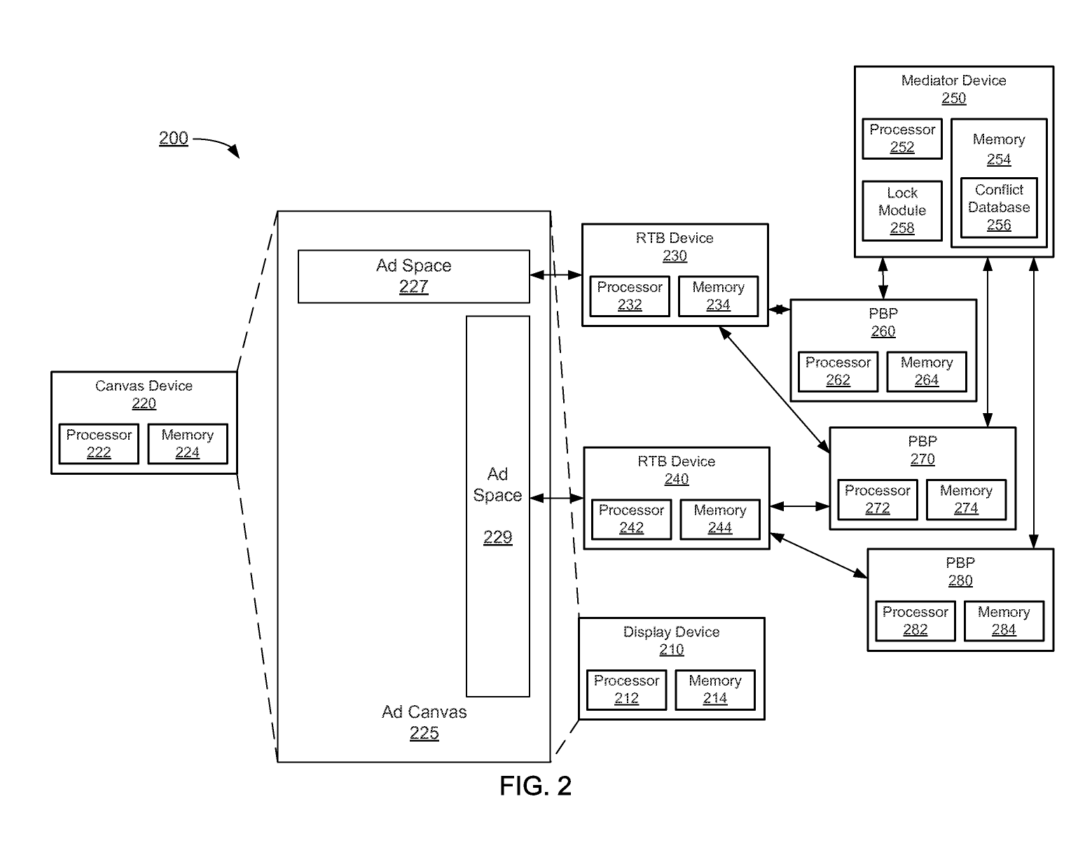

FIG. 2 is a schematic diagram of a system 200 for filling ad space 227, 229 on an advertisement canvas 225, according to an embodiment. The system 200 includes a canvas device 220, a display device 210, two real time bidding (RTB) devices 230, 240, three programmatic buying platforms (PBPs) 260, 270, 280, and a mediator device 250. In other embodiments, a system can have any number of canvas devices, display devices, RTB devices, PBPs, and/or mediator devices.

The canvas device 220, the display device 210, the RTB devices 230, 240, the PBPs 260, 270, 280, and/or the mediator device 250 can be communicatively coupled, e.g., via a network or networks (such as the internet, an intranet, a LAN, a WAN, a virtual network, a telecommunications network, etc.) implemented as a wired network and/or wireless network.

The canvas device 220, the display device 210, and the mediator device 250 can each be structurally and/or functionally similar to the canvas device 120, the display device 110, and/or the mediator device 150, respectively, described above with reference to FIG. 1. For example, the processors 222, 212, 252, the memories 224, 214, 254, the lock module 258, and/or the conflict database 256, can each be structurally and/or functionally similar to the corresponding processors 122, 112, 152, memories 124, 114, 154, lock module 158, and/or conflict database 156, respectively, as shown and described above with reference to FIG. 1.

The RTB devices 230, 240 can each be computing entities. The RTB devices 230, 240 can include memory 234, 244, and processors 232, 242, respectively. The memory 234, 244 and/or the processors 232, 242 can be structurally similar to the memory 124 and/or the processor 122, respectively, described above with reference to FIG. 1.

The RTB devices 230, 240 can be operable to conduct an auction to fill the ad space 227, 229, of the advertisement canvas 225. For example, the canvas device 220 can send, to the display device 210, code representing a webpage. The code representing the webpage, when implemented by a browser, can direct the display device 210 to request to be served advertisements to fill the ad spaces 227, 229. The display device 210 can be directed to the first RTB device 230 to fill the first ad space 227, and the second RTB device 240 to fill the second ad space 229. The RTB devices 230, 240 can conduct auctions to fill the ad spaces 227, 229, respectively. Each RTB device 230, 240 can conduct an independent auction. For example, the first RTB device 230 can conduct an auction substantially simultaneous with and/or without consulting the second RTB device 240, and vice versa.

The RTB devices 230, 240 each can conduct its auction by soliciting bids to place advertisements in the ad space 227, 229, respectively. For example, the RTB devices 230, 240, can send signals notifying the PBPs 260, 270, 280 of the auction. Notifying the PBPs 260, 270, 280 of the auction can include providing an indication of the advertisement canvas 225 (e.g., a URL associated with the advertisement canvas 225) and/or the display device 210 (e.g., the contents of a tracking cookie or other identifier stored in the memory 214 of the display device 210). Each RTB 230, 240 can have a network of PBPs from which it can solicit bids. As shown, the first RTB device 230 is operable to communicate with the first PBP 260 and the second PBP 270, while the second RTB device 240 is operable to communicate with the second PBP 270 and the third PBP 280.

The PBPs 260, 270, 280 can each be computing entities. The PBPs 260, 270, 280 can include memory 264, 274, 284 and processors 262, 272, 282, respectively. The memory 264, 274, 284 and/or the processors 262, 272, 282 can be structurally similar to the memory 124 and/or the processor 122, respectively, described above with reference to FIG. 1.

The PBPs 260, 270, 280 can be operable to select an advertisement to fill the ad space 227, 229 offered by the RTBs 230, 240. For example, the PBPs 260, 270, 280 can receive an invitation to bid containing an indication of the advertisement canvas 225 and/or the display device 210, and can select both an advertisement and an offer of compensation if the advertisement is used to fill the ad space 227, 229. PBPs 260, 270, 280 can store a list of advertisements, advertisers, bidding criteria, etc., e.g., in memory 264, 274, 284. PBPs 260, 270, 280 can choose to bid advertisements based on information about the display device on which the advertisement is going to appear. For example, PBP 260, 270, 280 can adjust the offered compensation based on how many times the advertisement has been viewed by the user of the display device 210, characteristics of the user of the display device 210, (e.g., browsing history, demographic data, etc.), and so forth.

A given advertiser can have a relationship with any number of PBPs. For example, each of the PBPs 260, 270, 280 can be operable to select an advertisement associated with a common given advertiser to fill an ad space. In instances where multiple PBPs having a relationship with a common given advertiser are offering an advertisement to fill a different ad space, an advertising collision can result. In instances where multiple PBPs having a relationship with a common given advertiser are offering advertisements to a single RTB, the PBPs may bid advertisements associated with that advertiser against each other.

Advertising collision and/or bidding advertisements against related advertisements can be reduced through the use of the mediator device 250. The PBPs 260, 270, 280 can send a signal to the mediator device 250 including an indication of the bid advertisement, the display device 210, the canvas device 220, and/or the user of the display device 210, etc. By sending a signal to the mediator device 250, the PBP 260, 270, 280 can verify that an advertisement selected for bidding does not conflict with an advertisement selected for bidding by another PBP 260, 270, 280. In this way, PBPs 260, 270, 280, which may be selecting advertisements for different RTBs 230, 240 and/or for placement in different ad spaces 227, 229, can verify that the advertisement selected will not conflict with another advertisement selected by another RTB 230, 240. As shown and described with reference to FIG. 1, the mediator device 250 can be operable to check a conflict database 256 and/or define a lock indicator with a lock module 258. The mediator device 250 can send a signal of approval or a signal of disapproval to a PBP 260, 270, 280.

If a PBP 260, 270, 280 receives a signal of disapproval from the mediator device 250, that PBP 260, 270, 280 can select another advertisement and send another signal to the mediator device 250 requesting approval. If a PBP 260, 270, 280 receives a signal of approval from the mediator device 250, that PBP 260, 270, 280 can be operable to bid advertisements in an auction conducted by an RTB 230, 240. For example, PBPs 260, 270, 280 can send a signal to an RTB 230, 240 including an offer to compensate the operator of the canvas device 220 in exchange for filling an ad space 227, 229 with a particular advertisement. The RTBs 230, 240 can receive bids from the PBPs 260, 270, 280 and can award the advertisement to the PBP 260, 270, 280 with the highest bid. In some embodiments, the RTBs 230, 240 can include a payment system operable to transfer payment between the winning PBP 260, 270, 280 and the canvas device 220.

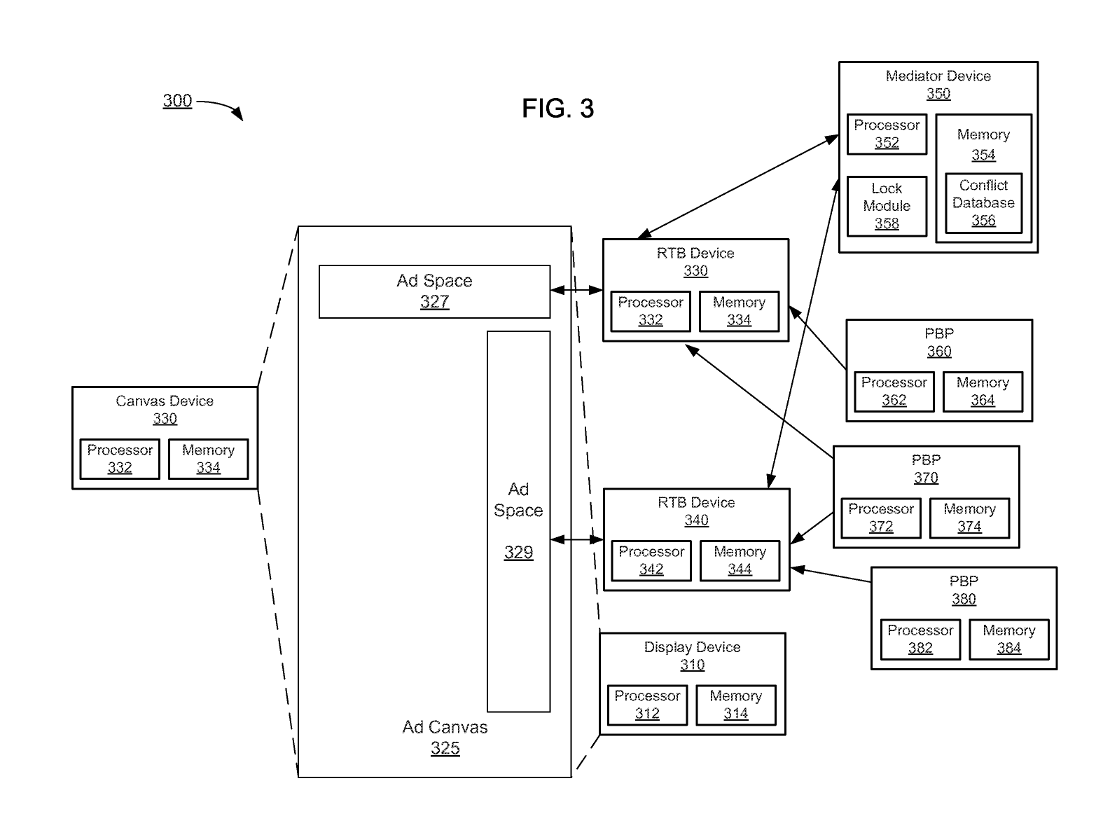

FIG. 3 is a schematic diagram of a system 300 for filling ad space 327, 329 on an advertisement canvas 325, according to an embodiment. The system 300 includes a canvas device 320, a display device 310, two real time bidding (RTB) devices 330, 340, three PBPs 360, 370, 380, and a mediator device 350. The canvas device 320, the display device 310, the RTBs 330, 340, the PBPs 360, 370, 380, and/or the mediator device 350 can be structurally and/or functionally similar to the canvas device 220, the display device 210, the RTBs 230, 240, the PBPs 260, 270, 280, and/or the mediator device 250 as shown and described above with reference to FIG. 2. For example, the processors 322, 312, 332, 342, 352, 362, 372, 382, the memories 324, 314, 334, 344, 354, 364, 374, 384, the lock module 358, and/or the conflict database 356, can each be structurally and/or functionally similar to the corresponding processors 222, 212, 232, 242, 252, 262, 272, 282, memories 224, 214, 234, 244, 254, 264, 274, 284, lock module 258, and/or conflict database 256, respectively, as shown and described above with reference to FIG. 2.

While the system 200 is shown and described with reference to FIG. 2 as having the PBPs 260, 270, 280 sending and receiving signals with the mediator device 250, in the system 300 of FIG. 3, the RTB devices 330, 340 can send signals to and/or receive signals from a mediator device 350. For example, the PBPs 360, 370, 380, can each receive an invitation to bid on the ad space 327, 329 from the RTB devices 330, 340, respectively, and can select an advertisement to bid without consulting the mediator device 350. The RTB devices 330, 340 can each conduct an auction and send an indication of the winning advertisement, the advertisement canvas 325, the display device 310, the user of the display device, etc., to the mediator device 350. The mediator device 350 can be operable to approve or deny the request to serve the advertisement. The mediator device 350 can send an indication of approval or disapproval, respectively, to the RTB devices 330, 340.

If either RTB device 330, 340 receives an indication of disapproval from the mediator device 350, in some embodiments, a next-highest bid can be selected and submitted to the mediator device 350 for approval.

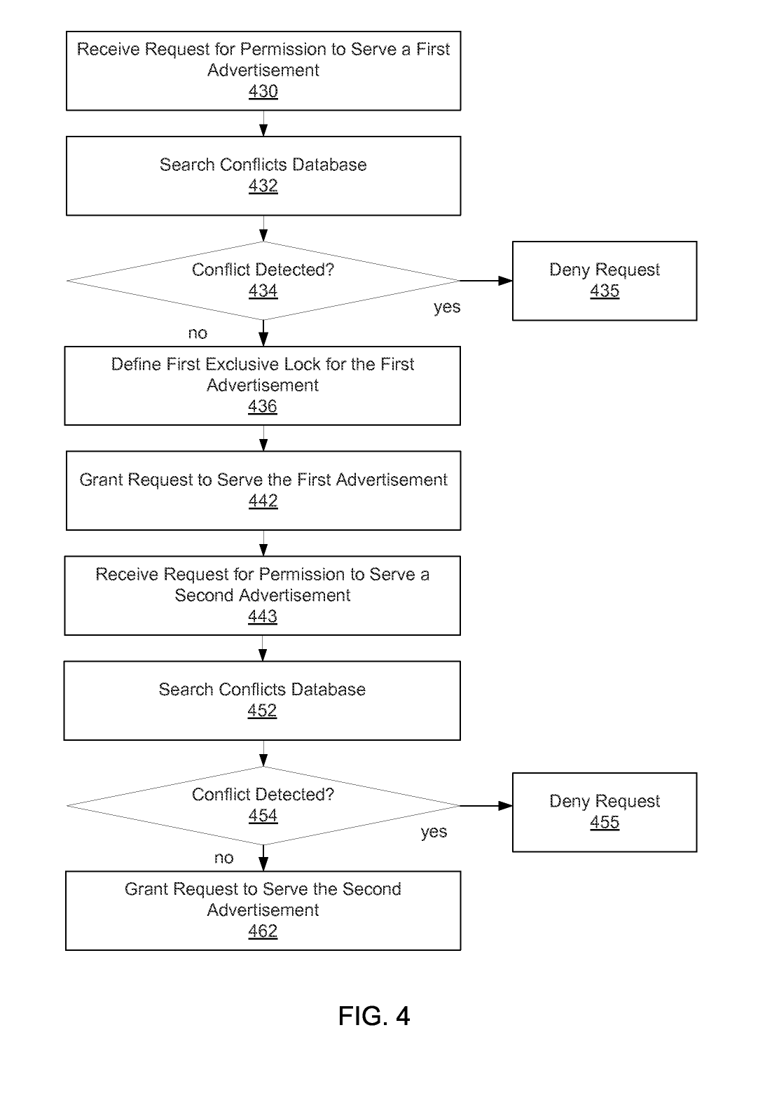

FIG. 4 is a flowchart of a method of operating a mediator device (e.g., the mediator device 150, 250, 350 as shown and described with reference to FIGS. 1-3), according to an embodiment. A request for permission to serve a first advertisement is received, at 430, from an advertisement device (e.g., the advertisement devices 130, 140, as shown and described with reference to FIG.1, the RTB devices 230, 240, as shown and described in FIG. 2, and/or the PBPs 360, 370, 380, as shown and described in FIG. 3). The request for permission can include an indication of the advertiser, an indication of the advertisement canvas on which the advertisement would be served, and/or an indication of the target of the advertisement, etc. The mediator device can search a conflicts database, at 432. The conflicts database can include rules and restrictions regarding how various advertisements can be served. For example, advertisers can maintain accounts with the mediator device and provide rules regarding how they wish their advertisements to appear (or not appear). An advertiser may wish for its advertisements to appear a limited number of times (e.g., once, twice, etc.) on a single advertisement canvas (e.g., a webpage), may not wish to appear on certain advertisement canvases (e.g., a manufacturer of children's toys may not wish their advertisements to appear on adult themed websites), may not wish to appear on the same advertisement canvas as competitors, and/or may not wish to appear on the same advertisement canvas as certain categories of other advertisements, and so forth.

Searching the conflicts database, at 432, can include verifying that presenting the advertisement will not conflict with any rules. If the request to serve the first advertisement, received at 430, conflicts with any restrictions associated with the advertisement, at 434, the mediator device can deny permission to serve the advertisement, at 435. In some embodiments, permission to serve the advertisement can be denied, at 435, by declining to send a signal approving the request.

If, however, no conflicts are detected, at 434, the mediator device can define an exclusive lock, at 436. Defining the exclusive lock, at 436, can include adding an entry into the conflicts database. In some embodiments, the exclusive lock can be associated with at least two of the advertisement, the advertiser, the advertisement category, the display device, the user of the display device, and/or the advertisement canvas. For example, an exclusive advertiser-advertisement canvas can be defined and that can be operable to prevent additional advertisements associated with the advertiser from being placed on the same advertisement canvas. Similarly, an exclusive advertiser-user lock can be operable to prevent additional ads from the same advertiser from being presented to the same user (identified, e.g., by a tracking cookie). Any other suitable type of lock (e.g., black lists, white lists, conditional locks, etc.) can be defined, at 435. A signal indicating approval to serve the first advertisement can be sent, at 442.

The mediator device can receive a request for permission to serve a second advertisement, at 443. The request for permission to serve the second advertisement, at 443, can be similar to the first request to serve a first advertisement, received at 430. In some instances, such as instances where multiple servers are operable to serve advertisements on a single advertisement canvas, the request for permission to serve the second advertisement, at 443, can be a request to serve a second advertisement to the same advertisement canvas.

Upon receiving the request to serve the second advertisement, at 443, the mediator device can again search the conflict database, at 452. The mediator device can be operable to detect a conflict if the exclusive lock defined for the first advertisement, at 435, conflicts with the request to serve the second advertisement. For example, if an advertiser-advertisement canvas lock was defined for the first advertisement, at 435, and if the request to serve the second advertisement is a request to serve another advertisement associated with the advertiser to the same advertisement canvas, a conflict can be detected, at 454, and the request can be denied, at 455. If, however, no conflict is detected with the second advertisement, a signal indicating approval to serve the second advertisement can be sent, at 462.

In some embodiments, after sending a denial of a request to serve an advertisement to an advertisement device, at 454, the method can include receiving a request to serve a third advertisement. The mediator device can again search the conflicts database and can approve the third advertisement if there is no conflict, or can deny the request to serve the third advertisement if a conflict is identified. This process can be repeated any number of times.

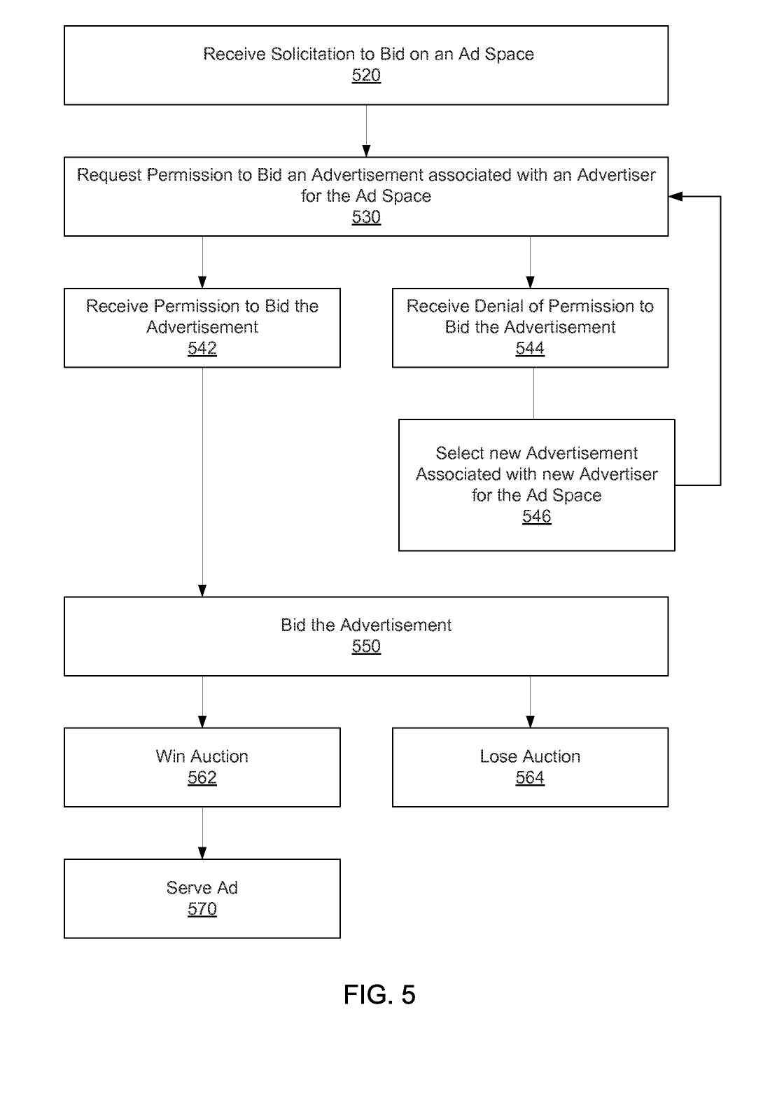

FIG. 5 is a method of operating a PBP, according to an embodiment. The PBP can receive a solicitation to bid on an ad space, e.g., from a RTB device, at 520. The solicitation to bid on the ad space can include information about the ad space, such as an indication of the advertisement canvas on which the ad space appears, an indication of the viewer of the ad space, browsing history of the viewer of the ad space, etc.

In some instances, (e.g., the system 200 as shown and described with reference to FIG. 2), the PBP can request permission from a mediator device to bid an advertisement, at 530. The request for permission, at 530, can include sending information associated with the advertisement, such as the advertiser, the advertisement canvas, the viewer, and/or the browsing history of the viewer, etc. to a mediator device. The PBP can receive either permission to bid the advertisement, at 542, or denial, at 544.

If the PBP receives a denial, at 544, a new advertisement can be selected, at 546. The new advertisement selected, at 546, can be associated with a different advertiser than the advertisement selected, at 530. For example, because the rejection of permission to bid the advertisement, at 544, can be in response to an exclusive lock associated with the advertiser, selecting a new advertisement associated with a new advertiser may be less likely to be rejected. In some instances, selecting a new advertisement, at 546, can include selecting a new advertisement having a different category than the advertisement selected, at 546. For example, if the first advertisement selected at 530 is an advertisement for apparel, the second advertisement selected at 546 can be an automotive advertisement. Selecting a new advertisement having a different category can be less likely to be likely to be rejected if the rejection, at 544, results from an exclusive advertisement canvas-category lock. In some instances, receiving the denial, at 544, can include receiving an indication of the reason for the denial. In such an instance, selecting the new advertisement, at 546, can be based on this indication of the reason for the denial and can include selecting a new advertisement that will not trigger the same denial.

If the PBP receives permission to bid the advertisement, at 542, the PBP can send, at 550, a signal including an indication of the advertisement and an offer for compensation if the advertisement is selected. After placing a bid, at 550, the PBP can receive an indication that the auction was won, at 562, or an indication the auction was lost, at 564. For example, the RTB device can conduct an auction and award the ad space to the highest bid satisfying the conditions of the auction.

If the PBP wins the auction, at 562, in some embodiments, the PBP can be operable to serve the winning advertisement to the ad space. For example, in some embodiments, the RTB device can be operable to instruct the display device to retrieve advertising content from the winning PBP.

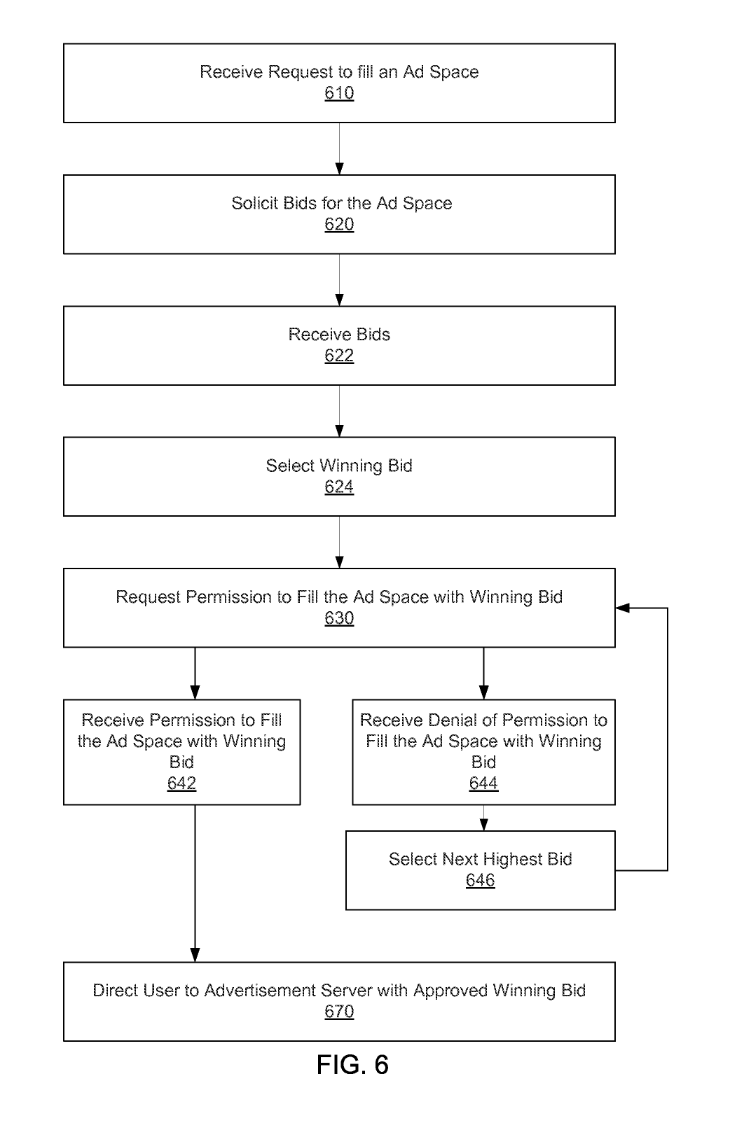

FIG. 6 is a method of operating an RTB, according to an embodiment. The RTB can receive a request to fill an ad space, at 610. For example, a user, using a user device, can access, display, and/or activate an advertisement canvas containing and/or associated with instructions to request advertising content from the RTB. The RTB can solicit bids for the ad space, at 620. Soliciting the bids can include sending a signal to PBPs requesting bids for the ad space. The RTB can send information, such as information about the advertisement canvas on which the ad space appears, an indication of the viewer of the ad space, and/or browsing history of the viewer of the ad space, etc. The RTB can receive bids, at 622, from PBPs in response and can select a winning bid, at 624. In some embodiments, e.g., the system 300 as shown and described above with reference to FIG. 3, the RTB can request permission from a mediator device to fill the ad space with the winning bid, at 630.

As shown and described, for example, with reference to FIG. 4, upon receiving a request for permission to fill the ad space, the mediator device can be operable to search a conflict database and/or define a lock indicator. Searching the conflict database can include determining if an exclusive lock has been defined and/or can be operable to prevent the RTB from filling the ad space with an advertisement that conflicts with a previously selected advertisement. Defining the lock indicator can include placing an entry into the conflict database and/or can be operable to prevent another RTB from filling another ad space with an advertisement that conflicts with advertisement of the winning bid.

The mediator device can either grant permission to fill the ad space with the winning advertisement, at 642, for example, if the mediator device does not detect a conflict, or deny permission, at 644, for example, if the mediator device does detect a conflict. If the mediator device grants permission to fill the ad space with the winning advertisement, at 642, the RTB can direct the display device to an advertisement server to fill the advertisement space, at 670. For example, the RTB device can send code to the display device providing instructions to obtain the advertisement content from the winning PBP.

If the mediator device denies permission to fill the ad space with the winning advertisement, at 644, the RTB device can select the next highest bid, at 646, and can request permission from the mediator device to serve the advertisement associated with the next highest bid, at 630. This process can be repeated until an approved advertisement is selected to fill the advertisement space, until a time limit is reached, or until a signal indicating a final denial and/or an end of the auction is received.

Some embodiments described herein relate computing entities. Computing entities can include a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

While various embodiments have been described above, it should be understood that they have been presented by way of example only, and not limitation. Where methods described above indicate certain events occurring in certain order, the ordering of certain events may be modified. Additionally, certain of the events may be performed concurrently in a parallel process when possible, as well as performed sequentially as described above.

Where schematics and/or embodiments described above indicate certain components arranged in certain orientations or positions, the arrangement of components may be modified. For example, while some embodiments are shown having a mediator device separate from other computing entities, such as advertisement devices, RTBs, and/or PBPs, in some embodiments, a single computing entity can perform the functions of a mediator device and an advertisement device, an RTB, and/or PBP. Similarly, the functions of any computing entities described herein can be performed in whole or in part by any other computing entity.

Some embodiments discussed above describe defining a lock indicator associated with a display device. In addition or alternatively, a lock indicator can be associated with a group of related display devices. For example, a group of display devices can be associated with a common user, a common IP address, a common location (e.g., identified via geolocation data), a common user account, and/or any other suitable common identifier. In some embodiments, an advertisement device and/or a mediator device can be operable to detect that a display device has been associated with one or more IP addresses, locations, and/or used to log into one or more user accounts. The advertisement device and/or mediator device can associate other display devices having similar usage patterns with a common user and/or a common group identifier. For example, a user may routinely access the internet with his laptop computer at his home and at his office. The advertisement device and/or the mediator device can be operable to recognize that a smart phone has a similar usage pattern and can associate the smart phone with the laptop computer, the user, the office, the home, and/or any other suitable group identifier. A lock indicator generated when the user requests an advertisement canvas via his laptop computer can be operable to prevent advertisement collision via the smart phone. For example, the mediator device can be operable to prevent advertisements associated with the same advertiser to be served via any display devices associated with the user and/or group.

While the embodiments have been particularly shown and described, it will be understood that various changes in form and details may be made. Although various embodiments have been described as having particular features and/or combinations of components, other embodiments are possible having a combination of any features and/or components from any of embodiments as discussed above.

What is claimed is:

1. A non-transitory processor-readable medium storing code representing instructions to be executed by a processor, the code comprising code to cause the processor to:
receive, at a first time and from a first advertisement device, a request for permission to serve a first advertisement to a first display device, the request from the first advertisement device including an indication of a first advertiser;
set a lock indicator to an active state in response to the request from the first advertisement device;
send, to the first advertisement device, approval to serve the first advertisement;
receive, at a second time after the first time and from a second advertisement device, a request for permission to serve a second advertisement to a second display device, the request from the second advertisement device including an indication of a second advertiser; and
decline to send, to the second advertisement device, approval to serve the second advertisement when the lock indicator is in the active state.

2. The non-transitory processor-readable medium of claim 1, the code further comprises code to cause the processor to:
send, to the second advertisement device, a denial of the request for permission to serve the second advertisement.

3. The non-transitory processor readable medium of claim 1, wherein at least one of the first advertisement device or the second advertisement device is a programmatic buying platform.

4. The non-transitory processor readable medium of claim 1, wherein at least one of the first advertisement device or the second advertisement device is a real-time bidding device.

5. The non-transitory processor readable medium of claim 1, further comprising:
set the lock indicator to an inactive state after a period of time.

6. The non-transitory processor readable medium of claim 1, wherein:
the first display device is the second display device,
the request from the first advertisement device includes an indication of an advertisement canvas,
the lock indicator is associated with the advertisement canvas, the code to decline includes code to decline to send the approval such that the first display device is prevented from being served more than one advertisement associated with the first advertiser on the advertisement canvas.

7. The non-transitory processor readable medium of claim 1, wherein:
the first display device is not the second display device, the first display device is associated with a user, the second display device is associated with the user,
the request from the first advertisement device includes an indication associated with the user,
the lock indicator is associated with the user, the code to decline includes code to decline to send approval such that the second display device is prevented from being served an advertisement associated the first advertiser.

8. The non-transitory processor readable medium of claim 1, the code further comprising code to cause the processor to:
verify, in response to receiving the request from the first advertisement device, that no lock indicator associated with the first advertiser and the first display device is in an active state.

9. The non-transitory processor readable medium of claim 1, the code further comprising code to cause the processor to:
verify, in response to receiving the request from the first advertisement device, that no lock indicator associated with the first advertiser and the first display device is an active state, such that the verifying and the setting the lock indicator is performed substantially simultaneously.

10. The non-transitory processor readable medium of claim 1, wherein one millisecond or less elapses between the receiving the request to serve the first advertisement and the sending approval to serve the first advertisement.

11. The non-transitory processor readable medium of claim 1, wherein:
the first display device is the second display device,
the request for permission to serve the first advertisement is a request to fill a first ad space on a web page accessed by the first display device, the request for permission to serve the second advertisement is a request to fill a second ad space on the web page accessed by the first display device.

12. The non-transitory processor readable medium of claim 1, wherein the first advertiser is the second advertiser, the code further comprising code to cause the processor to:
verify, in response to receiving the request from the second advertisement device, that the lock indicator is associated with the second advertiser.

13. The non-transitory processor readable medium of claim 1, wherein the first advertiser is not the second advertiser, the first advertiser is associated with a category of advertiser and the second advertiser is associated with the category of advertiser,
the lock indicator is associated with the category of advertiser, the code further comprising code to cause the processor to:
verify, in response to receiving the request from the second advertisement device, that the lock indicator is associated with the category of advertiser.

14. The non-transitory processor readable medium of claim 1, wherein the lock indicator is associated with a black list, the code further comprising code to cause the processor to:
verify, in response to receiving the request from the second advertisement device, that the second advertiser is associated with the black list.

15. A non-transitory processor-readable medium storing code representing instructions to be executed by a processor, the code comprising code to cause the processor to:
receive, from a real-time bidding device, an invitation to participate in an auction for an ad space;
send, to a mediator device, a request to bid a first advertisement associated with an advertiser such that the mediator device defines a lock indicator in response to the request to bid that prevents a display device from being served a second advertisement associated with the advertiser when the lock indicator is in an active state; and
receive, from the mediator device, a response to the request to bid, the response including an indication of approval to bid or an indication of disapproval to bid.

16. The non-transitory processor readable medium of claim 15, wherein the response includes the indication of approval, the code further comprising code configured to cause the processor to:
send, to the real-time bidding device, a signal representing a bid on the ad space in response to receiving the indication of approval.

17. The non-transitory processor readable medium of claim 15, wherein the advertiser is a first advertiser, the response includes the indication of disapproval, the response from the mediator device is a first response from the mediator device, the code further comprising code to cause the processor to:
send, to the mediator device, a request to bid a third advertisement associated with a second advertiser;
receive, from the mediator device, a second response including the indication of approval to bid the third advertisement,
send, to the real-time bidding device, a signal representing a bid on the ad space and associated with the third advertisement in response to receiving the indication of approval.

18. The non-transitory processor readable medium of claim 15, wherein the response includes the indication of approval, the code further comprising code configured to cause the processor to:
send, to the real-time bidding device, a signal representing a bid on the ad space in response to receiving the indication of approval,
receive, from the display device, a request for the first advertisement; and
serve, to the display device, the first advertisement in response to the request for the advertisement.

19. A non-transitory processor-readable medium storing code representing instructions to be executed by a processor, the code comprising code to cause the processor to:
receive, from a first display device, a request to be served a first advertisement to fill an ad space;
receive, from a programmatic buying platform, a signal representing a bid for the ad space, the bid associated with an advertiser;
request permission to serve the first advertisement, the request including an indication of the advertiser;
receive an indicator of approval to serve the first advertisement such that a second display device is prevented from being served a second advertisement associated with the advertiser; and
redirect the first display device to the programmatic buying platform after receiving the indicator of approval.

20. The non-transitory processor readable medium of claim 19, wherein:
the code to cause the processor to request permission to serve the first advertisement includes code to cause the processor to send a signal to a mediator device, the mediator device configured to set a lock indicator to an active state in response to the signal requesting permission to serve the first advertisement,
the code to cause the processor to receive the indicator of approval includes code to receive a signal from the mediator device including the indicator of approval.

21. The non-transitory processor readable medium of claim 19, wherein the code to cause the processor to request permission to serve the first advertisement further includes code to cause the processor to:
search a conflict database to verify that no lock indicator associated with the advertiser is in an active state;
set the lock indicator to the active state after verifying that no lock indicator associated with the advertiser is in an active state; and
generate the indicator of approval after the lock indicator is set to the active state.

22. The non-transitory processor-readable medium of claim 19, wherein the programmatic buying platform is one of a plurality of programmatic buying platforms, the code configured to cause the processor to receive the signal representing the bid for the ad space includes code to cause the processor to:
receive a plurality of signals representing bids for the ad space from the plurality of programmatic buying platforms; and
select a high bid from the bids, the first advertisement associated with the high bid.

23. The non-transitory processor readable medium of claim 19, wherein:
the advertiser is a first advertiser,
the programmatic buying platform is one of a plurality of programmatic buying platforms,
the code to cause the processor to receive a signal representing a bid for the ad space further includes code to cause the processor to receive a plurality of signals representing bids for the ad space from the plurality of programmatic buying platforms,
the code further comprising code to cause the processor to:
select a high bid from the bids, a third advertisement associated with a second advertiser associated with the high bid;
send, to the mediator device, a request for permission to serve the third advertisement including an indication of the second advertiser;
receive, from the mediator device, an indication of disapproval of the request to serve the third advertisement;
select, in response to receiving the indication of disapproval, a next highest bid from the bids, the first advertisement associated with the next highest bid.

24. The non-transitory processor readable medium of claim 19, wherein the indication of approval is a period of time elapsing without receiving a signal including an indication of disapproval.

25. The non-transitory processor readable medium of claim 19, wherein the first display device is not the second display device, the first display device is associated with a user, the second display device is associated with the user.

26. The non-transitory processor readable medium of claim 19, wherein the first display device is the second display device.
